(19) United States
(12) Patent Application Publication
(10) Pub. No.: US 2014/0153046 A1
(43) Pub. Date: Jun. 5, 2014

(54) PRINTING APPARATUS, CONTROL METHOD THEREOF AND STORAGE MEDIUM

(71) Applicant: CANON KABUSHIKI KAISHA, Tokyo (JP)

(72) Inventor: Yoshinori Kuwano, Niigata-shi (JP)

(73) Assignee: CANON KABUSHIKI KAISHA, Tokyo (JP)

(21) Appl. No.: 14/083,041

(22) Filed: Nov. 18, 2013

(30) Foreign Application Priority Data
Dec. 3, 2012 (JP) 2012-264743

(51) Int. Cl. G06K 15/00

(52) U.S. Cl. CPC G06K 15/4065
USPC 358/1.15; 358/1.16

(57) ABSTRACT

In a printing apparatus which detects a size of a conveying sheet, even when sheets are replaced during execution of print processing, an incorrect size is suppressed from being stored as a size of sheets stored in a sheet storage unit. In order to achieve this, a printing apparatus of an aspect of this invention controls not to store a sheet size as a size of sheets stored in the sheet storage unit in a case where the sheet storage unit is opened during conveyance of a sheet, and controls to store a sheet size as the size of sheets stored in the sheet storage unit in a case where the sheet storage unit is not opened during conveyance of a sheet.

### BACKGROUND OF THE INVENTION

1. Field of the Invention

The present invention relates to a printing apparatus and control method thereof, and a storage medium.

2. Description of the Related Art

In an image forming apparatus including a sheet feeding unit which can stack a plurality of different sizes of sheets, the sizes of sheets stacked in the sheet feeding unit can be set by various methods. For example, in one method, when the sheet feeding unit of the image forming apparatus includes a sensor which can detect a stacked sheet size, the sheet size detected using such sensor is set (stored) as that corresponding to that sheet feeding unit. On the other hand, an image forming apparatus which does not include such sensor for the sake of a manufacturing cost reduction is available. In another method, such image forming apparatus includes, for example, a sensor which can measure a size of a sheet being conveyed, and, upon completion of conveyance of the sheet (completion of printing), sets the size measured by such sensor for the sheet feeding unit (Japanese Patent Laid-Open No. 11-301079). Also, Japanese Patent Laid-Open No. 8-267851 describes a method of updating, upon power-ON and after the sheet feeding unit is opened and closed, set (stored) size information since sheets stacked in the sheet feeding unit may be changed to those of a different size (the sheet size may be changed).

In such image forming apparatus, upon execution of print processing based on a print instruction, when a sheet size designated by the print instruction does not match a stored sheet size, an alarm message that advises accordingly is displayed, thus prompting the user to replace sheets to those of an appropriate size.

In the aforementioned image forming apparatus (printing apparatus), when a sheet is not to be successively fed during execution of print processing, sheets can be added or replaced by opening the sheet feeding unit during conveyance of a sheet. Such case includes, for example, print processing for only one sheet, or that for last one of a plurality of sheets. However, when the sheet feeding unit is opened and stacked sheets are replaced by those of a different size during an interval from when a sheet is fed from the sheet feeding unit upon execution of print processing until completion of conveyance (print processing), a size of the sheet detected during conveyance cannot often be correctly stored. This is because the printing apparatus stores a size of a conveyed sheet (a size of a sheet before replacement) upon completion of conveyance of the sheet.

### SUMMARY OF THE INVENTION

The present invention has been made in consideration of the aforementioned problem. The present invention provides a technique for preventing a printing apparatus which detects a size of a sheet being conveyed from storing an incorrect size as that of sheets stacked in a sheet feeding unit even when sheets are replaced during execution of print processing.

According to one aspect of the present invention, there is provided a printing apparatus comprising: a memory unit configured to store a size of a sheet stored in a sheet storage unit; an identifying unit configured to identify a size of a sheet conveyed from the sheet storage unit; and a control unit configured to control not to store the size of the sheet identified by the identifying unit as the size of the sheet stored in the sheet storage unit in a case where the sheet storage unit is opened during conveyance of the sheet, and to control to store the size of the sheet identified by the identifying unit as the size of the sheet stored in the sheet storage unit in a case where the sheet storage unit is not opened during conveyance of the sheet.

According to another aspect of the present invention, there is provided a control method of a printing apparatus comprising steps of: storing, in a memory unit, a size of a sheet stored in a sheet storage unit; identifying a size of a sheet conveyed from the sheet storage unit; and controlling not to store the size of the sheet identified in the identifying step as the size of the sheet stored in the sheet storage unit in a case where the sheet storage unit is opened during conveyance of the sheet, and controlling to store the size of the sheet identified in the identifying step as the size of the sheet stored in the sheet storage unit in a case where the sheet storage unit is not opened during conveyance of the sheet.

According to still another aspect of the present invention, there is provided a computer-readable storage medium storing a computer program for causing a computer to execute steps of a control method of a printing apparatus comprising steps of: storing, in a memory unit, a size of a sheet stored in a sheet storage unit; identifying a size of a sheet conveyed from the sheet storage unit; and controlling not to store the size of the sheet identified in the identifying step as the size of the sheet stored in the sheet storage unit in a case where the sheet storage unit is opened during conveyance of the sheet, and controlling to store the size of the sheet identified in the identifying step as the size of the sheet stored in the sheet storage unit in a case where the sheet storage unit is not opened during conveyance of the sheet.

According to the present invention, a technique for preventing a printing apparatus which detects a size of a sheet being conveyed from storing an incorrect size as that of sheets stacked in a sheet feeding unit even when sheets are replaced during execution of print processing.

Further features of the present invention will become apparent from the following description of exemplary embodiments (with reference to the attached drawings).

### BRIEF DESCRIPTION OF THE DRAWINGS

FIG. 1 is a view showing a configuration example of a network including a printing apparatus 101 according to an embodiment of the present invention;

FIG. 2 is a sectional view showing a hardware arrangement example of the printing apparatus 101 according to the embodiment of the present invention;

FIG. 3 is a block diagram showing a hardware arrangement example of the printing apparatus 101 according to the embodiment of the present invention;

FIGS. 4A to 4C are conceptual views showing an example of the operation of the printing apparatus 101 according to the embodiment of the present invention;

FIGS. 5A and 5B are conceptual views showing an example of the operation of the printing apparatus 101 according to the embodiment of the present invention; and

FIG. 6 is a flowchart showing the sequence of setting processing of size information of a sheet, which is executed by a CPU 301 in the printing apparatus 101 according to the embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Hardware Arrangement of Printing Apparatus 101>

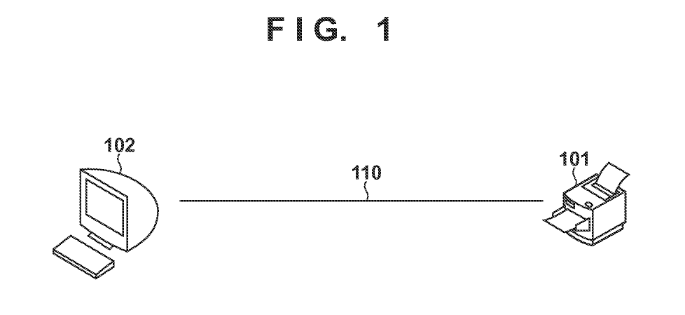

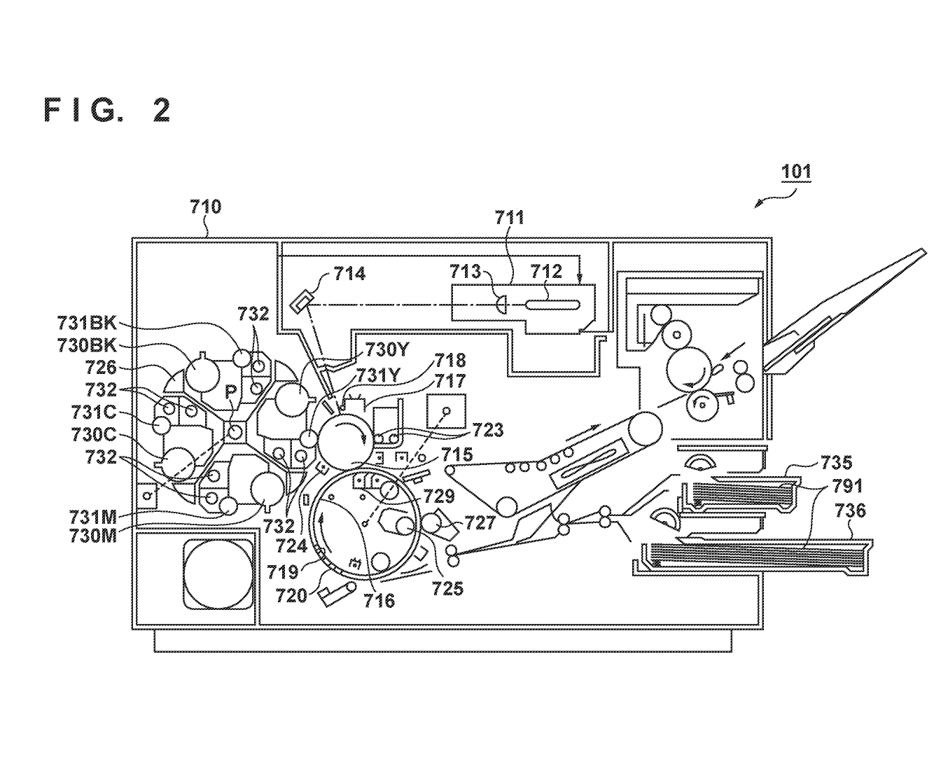

FIG. 1 is a view showing an example of a network configuration including a printing apparatus 101 according to an embodiment of the present invention. As shown in FIG. 1, the printing apparatus 101 is connected to a network 110 such as a LAN, and is connected to a PC 102 via the network 110 to be able to communicate with each other. However, the printing apparatus 101 may be connected to the PC 102 by USB connection via a USB cable in place of the network 110. The user operates the PC 102 to make settings related to print processing using an application which runs on the PC 102, and can cause the PC 102 to transmit an execution instruction of the print processing to the printing apparatus 101 together with the settings. The printing apparatus 101 can accept an execution instruction of print processing not only via an operation unit (an operation unit 340 in FIG. 2) but also from an external apparatus such as the PC 102 via the network 110.

FIG. 2 is a sectional view showing the hardware arrangement of the printing apparatus 101 according to the present embodiment. A scanner 711 includes a laser output unit (not shown) which converts an image signal into an optical signal, a polygon mirror 712 as a polyhedron (for example, an octahedron) having a plurality of reflecting surfaces, a motor (not shown) which rotates the polygon mirror 712, an f/θ lens (imaging lens) 713, and the like. The scanner 711 modulates a laser beam to be output from the laser output unit by an image signal corresponding to an original image, so as to irradiate a surface of a photosensitive drum 715 with the laser beam corresponding to the original image. The laser beam output from the laser output unit is reflected by any of the reflecting surfaces of the polygon mirror 712, passes through the f/θ lens 713 and a reflecting mirror 714, and linearly scans the surface of the photosensitive drum 715, which is rotating in a direction of an arrow. As a result, the surface of the photosensitive drum 715 is exposed, thereby forming an electrostatic latent image corresponding to the original image on the surface of the photosensitive drum 715.

Around the photosensitive drum 715, a primary charger 717, a full-surface exposure lamp 718, a cleaner unit 723 which recovers residual developing materials (toners) remaining on the surface of the photosensitive drum 715 without being transferred onto a sheet, a pre-transfer charger 724, and a developing unit 726 are arranged.

The developing unit 726 develops the electrostatic latent image formed on the surface of the photosensitive drum 715 with toner to form a toner image on the surface of the photosensitive drum 715. Around a central shaft P of the developing unit 726, developing sleeves 731Y, 731M, 731C, and 731Bk, toner cartridges 730Y, 730M, 730C, and 730Bk, and screws 732 are arranged. The toner cartridges 730Y, 730M, 730C, and 730Bk respectively hold toners of yellow (Y), magenta (M), cyan (C), and black (Bk). The screws 732 transfer toners. Each of the developing sleeves 731Y, 731M, 731C, and 731Bk is brought into contact with the photosensitive drum 715 to supply toner from the corresponding one of the toner cartridges 730Y, 730M, 730C, and 730Bk to the surface of the photosensitive drum 715, thereby developing the electrostatic latent image.

The printing apparatus 101 includes a door 710 which can be opened and closed by the user. By opening and closing the door 710, the user can replace the toner cartridges 730Y, 730M, 730C, and 730Bk located immediately under the door 710. Around a transfer roller 716 as a transfer charger, an actuator plate 719, position sensor 720, transfer drum cleaner 725, sheet pressing roller 727, and discharger 729 are arranged.

Sheets 729 are stored and stacked in Sheet feeding units (sheet feeding cassettes) 735 and 736. In the present embodiment, the sheet feeding units 735 and 736 do not include any sensor for detecting sizes of the stacked sheets 791. For this reason, the sheet feeding units 735 and 736 never automatically detect the sizes of the stacked sheets 791. On the other hand, the sheet feeding units 735 and 736 include sheet sensors (not shown) used to detect the presence/absence of stacked sheets. These sheet sensors can be used to detect that no sheet 791 stacked in the sheet feeding units 735 and 736 remain (are used up). In the present embodiment, the sheet feeding units 735 and 736 include sheet feeding unit open/close sensor (not shown) used to detect opening/closing operations required to, for example, add or replace sheets. Furthermore, a sensor (not shown) used to detect a size of a sheet being conveyed is arranged at an arbitrary position on a conveyance path on which a sheet fed from the sheet feeding unit 735 or 736 is conveyed.

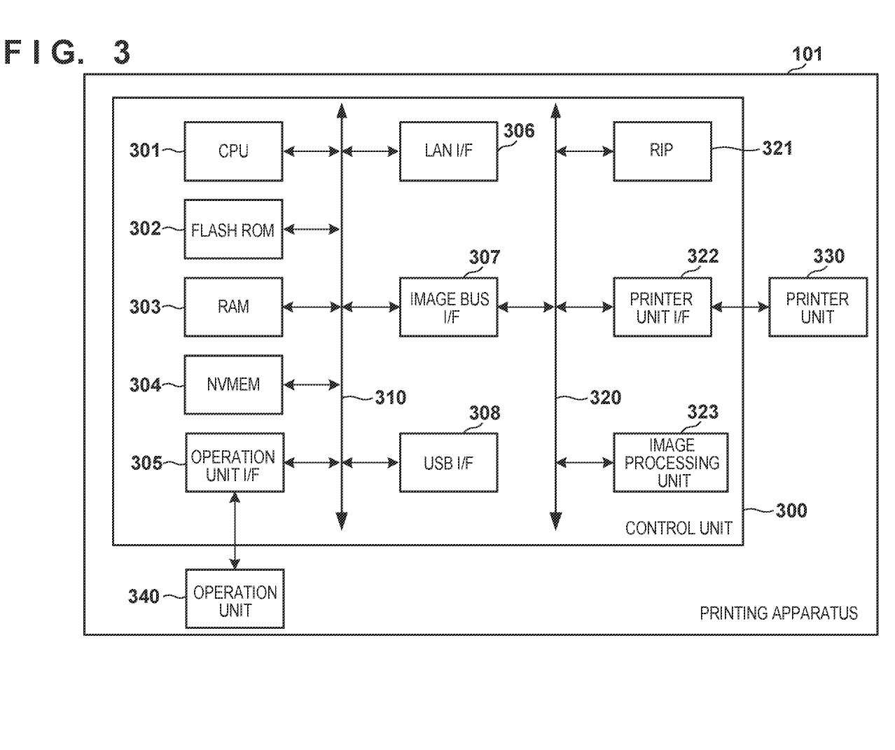

FIG. 3 is a block diagram showing the hardware arrangement of the printing apparatus 101 according to this embodiment. The printing apparatus 101 includes a control unit 300, and a printer unit 330 and operation unit 340, which are connected to the control unit 300. Note that the printing apparatus 101 may further include devices which are not shown in FIG. 3.

The printer unit 330 functions as an image output device which prints (outputs) an image based on image data onto a sheet. The printer unit 330 is a printer of an electrophotography type, inkjet type, or the like, and prints an image based on raster image data on a sheet. In the present embodiment, the printer unit 330 is a printer of an electrophotography system. The operation unit 340 includes an input unit such as a keyboard or touch panel and a display unit, accepts an instruction from the user, and displays a message for the user, a processing result, and the like using the display unit.

The control unit 300 includes a system bus 310 and image bus 320, to which various devices are connected. To the system bus 310, a CPU 301, flash ROM 302, RAM 303, NVMEM 304, operation unit interface (I/F) 305, LAN I/F 306, image bus I/F 307, and USB I/F 308 are connected. Also, to the image bus 320, an image bus I/F 307, raster image processor (RIP) 321, printer unit I/F 322, and image processing unit 323 are connected.

The CPU 301 is a processor which controls the operation of the overall printing apparatus 101. The flash ROM 302 is a rewritable nonvolatile memory, and stores various control programs required for the CPU 301 to control the operation of the printing apparatus 101. The RAM 303 provides a system work memory required for the CPU 301 to operate. The RAM 303 is used as a program memory used to expand control programs read out from the flash ROM 302 and as an image memory used to temporarily store image data to be printed by the printer unit 330. The NVMEM 304 is a nonvolatile memory, and stores setting information and the like. Note that another nonvolatile memory device such as a hard disk drive (HDD) may be used in place of the NVMEM 304. Note that in the present embodiment, the NVMEM 304 is an example of a memory unit which stores size information indicating a size of sheets stacked in each sheet feeding unit.

The operation unit I/F 305 is an interface used to connect the operation unit 340 and system bus 310, and transfers control information from the CPU 301 to the operation unit 340 via the system bus 310. Also, the operation unit I/F 305 transfers information input by the user using the operation unit 340 to the CPU 301 via the system bus 310.

The LAN I/F 306 is connected to the network (LAN) 110, and exchanges device information, image data, an execution instruction of print processing, and the like with the external apparatus via the network. The USB I/F 308 is an interface to which the external apparatus such as the PC 102 can be connected via USB connection. The image bus I/F 307 is an interface which connects the system bus 310 and the image bus 320 that can transfer image data at high speed, and serves as a bus bridge which converts data structures. The image bus 320 is configured by a PCI bus or IEEE1394.

The RIP 321 rasterizes vector data such as page description language (PDL) code into bitmap image data. The printer unit I/F 322 is an interface which connects the printer unit 330 and control unit 300, and executes synchronous system/asynchronous system conversion of image data, exchange of control commands, power supply, and the like. The image processing unit 323 executes correction, modification, and editing for input image data, and executes gamma correction, resolution conversion, and the like for image data for print output. Furthermore, the image processing unit 323 executes rotation of image data, compression/decompression processing (for example, JPEG) for multi-level image data, and compression/decompression processing (for example, JBIG, MMR, MH, or the like) for binary image data.

<Setting Processing of Size Information of Sheet>

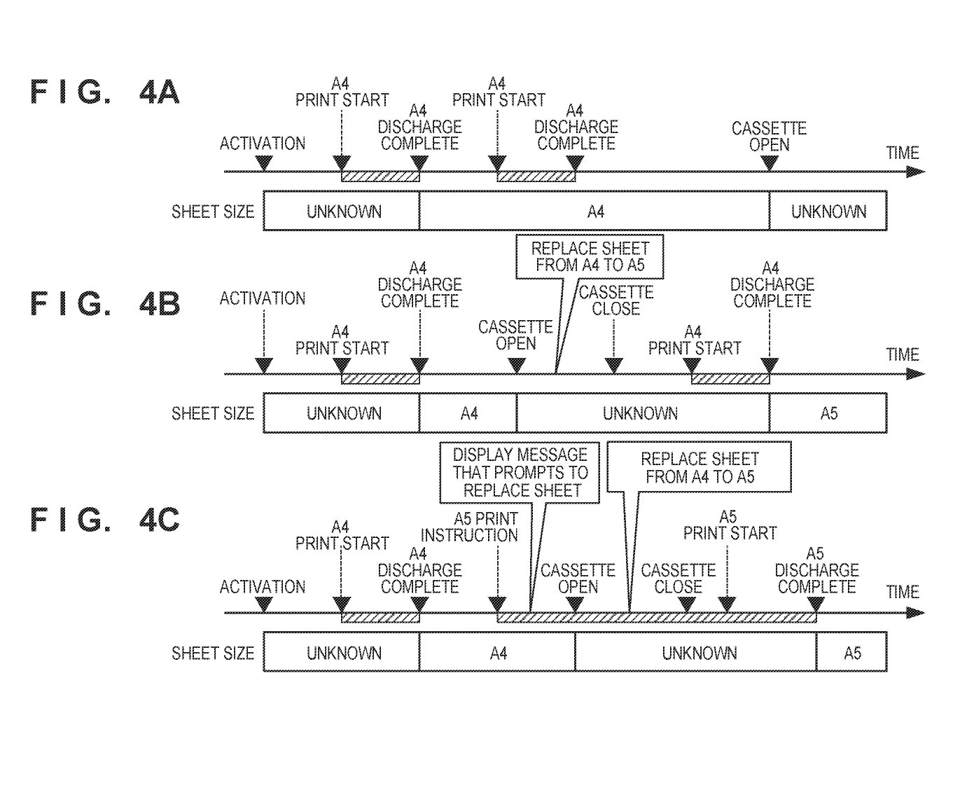

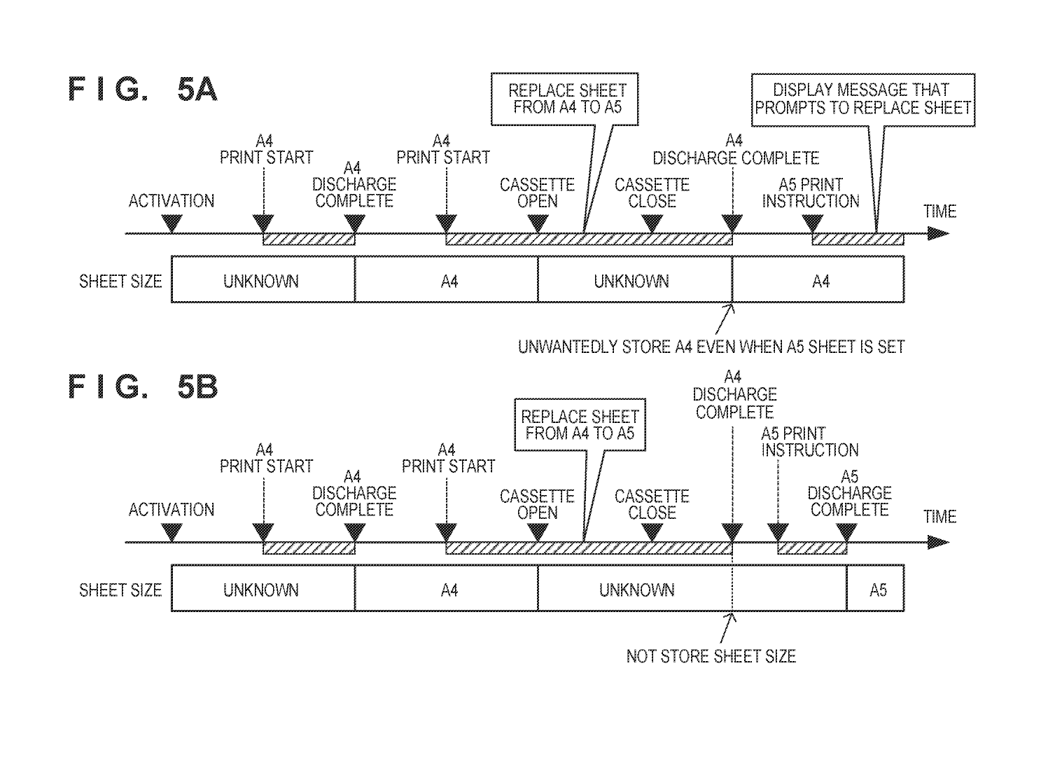

The operation of the printing apparatus 101 according to the present embodiment will be described below with reference to FIGS. 4A to 4C and FIGS. 5A and 5B. Note that a print operation by the printer unit 330 in the printing apparatus 101 is executed under the control of the CPU 301.

As described above, the printing apparatus 101 includes the sensor used to detect a size of a sheet, which is fed from the sheet feeding unit 735 or 736, and is being conveyed on the conveyance path. The printing apparatus 101 can measure, based on information output from this sensor, at least one of a size in a conveyance direction of a conveying sheet, and a size in a direction perpendicular to the conveyance direction. Furthermore, the printing apparatus 101 can automatically set sizes of sheets stacked in the sheet feeding units 735 and 736 based on the measurement result of the size of a sheet being conveyed even when the user does not set, in advance, sizes of sheets stacked in the sheet feeding units 735 and 736 via the operation unit 340.

FIGS. 4A to 4C show an example of the operation of the printing apparatus 101 according to the present embodiment. FIGS. 4A to 4C show size information of sheets stacked in the sheet feeding units 735 and 736 (the following description will be given using the sheet feeding unit 735), which information is stored in the NVMEM 304 and is stored in the printing apparatus 101. Note that “unknown” corresponds to an initialized state (a state of not being set) of size information, that is, a state in which a size of sheets stacked in the sheet feeding unit 735 is not identified, and is not stored in the printing apparatus 101. Also, assume that the stored size information is initialized at an activation timing of a power source of the printing apparatus 101.

As shown in FIG. 4A, after activation of the power source, the printing apparatus 101 starts printing using a sheet of an A4 size according to a print instruction, and identifies a size of that sheet during conveyance of the sheet upon execution of print processing, as described above. After that, the printing apparatus 101 stores the identified sheet size (A4) as that of sheets stacked in the sheet feeding unit 735 at a conveyance completion timing (or print processing completion timing). Note that when a plurality of sheets are continuously fed according to a print instruction, the printing apparatus 101 stores a sheet size upon completion of conveyance of all sheets. After that, when print processing is executed again according to a print instruction, as shown in FIG. 4A, the printing apparatus 101 executes the print processing using the stored sheet size (A4). For example, the printing apparatus 101 uses the stored sheet size in determination as to whether or not a sheet size designated by a print instruction matches that stacked in the sheet feeding unit 735, adjustment of a size of an image to be printed, and the like.

When the user opens the sheet feeding unit 735 after the sheet size is stored, the printing apparatus 101 clears (initializes) the stored sheet size. This is because sheets of a size different from those stacked so far are likely to be newly stacked in the sheet feeding unit 735. FIG. 4B shows a case in which the user opens the sheet feeding unit 735 and replaces sheets of the A4 size to those of an A5 size. In this case, upon reception of a new print instruction after replacement of the sheets, the printing apparatus 101 executes print processing by feeding a sheet from the sheet feeding unit 735, identifies a size of the sheet being conveyed, and stores the identified sheet size (A5) again at a conveyance completion timing of the sheet.

FIG. 4C shows a case in which a print instruction for using a sheet of the A5 size is received while the printing apparatus 101 stores the A4 size as information indicating a size of sheets stacked in the sheet feeding unit 735. In this case, since the sheet size (A5) designated by the print instruction is different from the stored sheet size (A4), the printing apparatus 101 displays a message, which prompts the user to replace sheets stacked in the sheet feeding unit 735, on the display unit before it starts execution of print processing based on the print instruction. After that, when the user opens the sheet feeding unit 735 to replace sheets according to the displayed message, the printing apparatus 101 initializes the stored sheet size. After the user completes replacement of sheets and closes the sheet feeding unit 735, the printing apparatus 101 starts print processing based on the print instruction, identifies a size of a sheet being conveyed, and stores the sheet size again at a conveyance completion timing of the sheet.

When sheets stacked in the sheet feeding unit 735 are replaced at a timing at which the printing apparatus 101 does not execute print processing, as shown in FIGS. 4B and 4C, the printing apparatus 101 can stores a correct size of sheets stacked in the sheet feeding unit 735. By contrast, FIG. 5A shows a case in which sheets are replaced during execution of print processing by the printing apparatus 101 (during conveyance of a sheet). Note that when a plurality of sheets are continuously fed according to a print instruction, the sheet feeding unit 735 can be opened and closed only during conveyance of the last sheet of the plurality of sheets, and is locked during conveyance of a sheet other than the last sheet.

When sheets are replaced during execution of print processing (during conveyance of a sheet), the printing apparatus 101 is unlikely to stores a correct size of new sheets stacked in the sheet feeding unit 735. In FIG. 5A, at the print processing start timing, the printing apparatus 101 stores the A4 size, and executes printing on a sheet of the A4 size. In this case, when sheets stacked in the sheet feeding unit 735 are replaced from those of the A4 size to those of the A5 size during execution of the print processing (for the last one sheet of the A4 size), the printing apparatus 101 clears the memorized sheet size in response to opening of the sheet feeding unit 735. However, the printing apparatus 101 stores not the A5 size but the A4 size as a size of sheets stacked in the sheet feeding unit 735 at the discharge completion timing of the last sheet of the A4 size.

Then, in the printing apparatus 101, the stored sheet size mismatches the size of sheets actually stacked in the sheet feeding unit 735. As a result, for example, even when the user inputs an execution instruction of print processing using a sheet of the A5 size, the printing apparatus 101 judges that a mismatch of sheet sizes has occurred irrespective of sheets of the A5 size being stacked in the sheet feeding unit 735. Furthermore, the printing apparatus 101 displays the aforementioned message without executing print processing, and a phenomenon that the print processing cannot be executed may occur.

In order to avoid such phenomenon, the printing apparatus 101 executes the following processing when it detects a possibility of replacement of sheets stacked in the sheet feeding unit 735 to those of a different size during execution of print processing, as shown in FIG. 5B. That is, the printing apparatus 101 does not store a size identified in association with a sheet being conveyed as a size of sheets stacked in the sheet feeding unit 735 upon completion of the print processing. On the other hand, the printing apparatus 101 stores a sheet size upon completion of print processing when it detects a possibility of replacement of sheets stacked in the sheet feeding unit 735 to those of a different size before the start of execution of the print processing. With this processing, the printing apparatus 101 can store a sheet size identified during conveyance of a sheet without any error, and can appropriately use the stored sheet size so as to execute print processing using a sheet of a size designated by a print instruction.

Also, when the printing apparatus 101 does not store a size identified for a sheet being conveyed as that of sheets stacked in the sheet feeding unit 735 upon completion of the print processing, it may identify and store a sheet size again upon execution of the next print processing.

Note that sheets stacked in the sheet feeding unit 735 or 736 may be replaced to those of a different size in, for example, the following cases. That is, sheets stacked in the sheet feeding unit 735 or 736 may be replaced to those of a different size in a case where the sheet feeding unit 735 or 736 is opened and closed, or a case where no sheet remains in the sheet feeding unit 735 or 736 upon completion of conveyance of a sheet due to execution of print processing. Also, sheets may be replaced while the power source of the printing apparatus 101 is OFF, and sheets stacked in the sheet feeding unit 735 or 736 may have already been replaced to those of a different size when the power source of the printing apparatus 101 is turned on. Therefore, when the printing apparatus 101 (CPU 301) detects these states, it can judge that sheets stacked in the sheet feeding unit 735 or 736 may be replaced to those of a different size.

<Practical Example of Setting Processing of Size Information of Sheet>

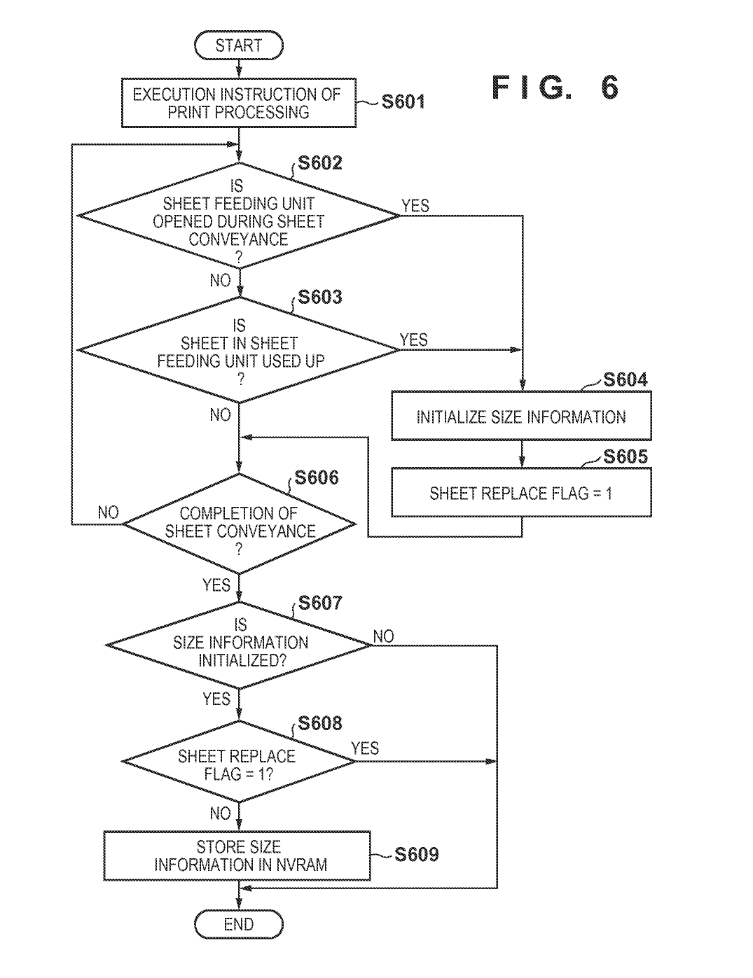

A practical embodiment related to setting processing of size information of a sheet in the printing apparatus 101 will be described below with reference to FIG. 6. FIG. 6 is a flowchart showing the sequence of setting processing of size information of a sheet, which is executed by the CPU 301 in the printing apparatus 101 according to this embodiment. The processing shown in this flowchart is that required for the CPU 301 to set a size of a sheet identified during conveyance of that sheet as a sheet size to be stored by the printing apparatus 101 upon completion of conveyance of the sheet (or completion of print processing). Note that the processing shown in this flowchart is implemented on the printing apparatus 101 when the CPU 301 reads out a control program stored in the flash ROM 302 to be loaded on the RAM 303, and executes the loaded program.

The CPU 301 accepts an execution instruction of print processing (print instruction) from the PC 102 via the USB I/F 308 or LAN I/F 306, or from the operation unit 340 according to a user operation. Upon acceptance of the print instruction, the CPU 301 instructs the printer unit 330 to execute print processing based on the print instruction via the printer unit I/F 322. In this print instruction, a size of a sheet used in printing and a sheet feeding unit to be used as a sheet feeding source can be designated as print settings. Assume that in the following description, the sheet feeding unit 735 is designated as a sheet feeding source in the print settings. Also, assume that size information corresponding to the sheet feeding unit 735 is set (not initialized) in the NVMEM 304, and that the set size information matches a sheet size designated by the print settings.

In step S601, the CPU 301 instructs the printer unit 330 to execute print processing via the printer unit I/F 322. In response to this, the printer unit 330 transfers, to the CPU 301, a signal indicating that feeding of a sheet from the sheet feeding unit 735 is started. When a sheet is fed from the sheet feeding unit 735 upon execution of print processing and is conveyed on the conveyance path, the sensor arranged on the conveyance path detects a size of the sheet being conveyed. The printer unit 330 transfers output information from this sensor to the CPU 301 via the printer unit I/F 322. The CPU 301 identifies a size of the sheet which is being conveyed on the conveyance path based on the transferred output information, and holds information indicating the identified sheet size in the RAM 303 until completion of the print processing.

When the print processing by the printer unit 330 is started, the CPU 301 determines in step S602 based on a notification from the printer unit 330 via the printer unit I/F 322 whether or not the sheet feeding unit 735 is opened during conveyance of the sheet. If the CPU 301 determines that the sheet feeding unit 735 is not opened, the CPU 301 advances the process to step S603, where the CPU 301 determines based on a notification from the printer unit 330 via the printer unit I/F 322 whether or not sheets stacked in the sheet feeding unit 735 are used up.

If the CPU 301 determines in step S602 that the sheet feeding unit 735 is opened or determines in step S603 that sheets stacked in the sheet feeding unit 735 are used up, it determines that sheets stacked in the sheet feeding unit 735 may be replaced to those of a different size. In this case, the CPU 301 advances the process to step S604, where the CPU 301 initializes the size information corresponding to the sheet feeding unit 735 (that is, makes the size information a state of not being set), which information is stored in the NVMEM 304. Furthermore, the CPU advances the process to step S605, where the CPU 301 sets “1” in a sheet replace flag stored in the NVMEM 304. An initial value of the sheet replace flag is “0”. When sheets stacked in the sheet feeding unit 735 may be replaced to those of a different size and the corresponding size information is initialized, this flag is set to be “1” to indicate this fact.

Note that in the present embodiment, the sheet feeding units 735 and 736 are sheet feeding cassettes which can be opened and closed so as to add or replace sheets. Alternatively, a sheet feeding tray of a tray type which cannot be opened and closed may be used. In this case, when the CPU 301 detects removal and placement of sheets with respect to the sheet feeding tray using a sensor provided to the sheet feeding tray, it judges that stacked sheets may be replaced to those of a different size.

After the processing of step S605 or if the CPU 301 determines in step S603 that sheets stacked in the sheet feeding unit 735 are not used up (remain), it advances the process to step S606. The CPU 301 determines in step S606 based on a notification from the printer unit 330 via the printer unit I/F 322 whether or not conveyance of all sheets based on the execution instruction of the print processing is complete (or whether or not the print processing is complete). If the CPU 301 determines that conveyance of sheets is not complete yet, it returns the process to step S602; otherwise, it advances the process to step S607.

The CPU 301 determines in step S607 whether or not the size information corresponding to the sheet feeding unit 735, which information is stored in the NVMEM 304, is initialized (that is, it is not set). If the CPU 301 determines that the size information is not initialized, it completes the print processing based on the print instruction. On the other hand, if the CPU 301 determines that the size information is initialized, it advances the process to step S608.

The CPU 301 determines in step S608 whether or not the sheet replace flag is set to be “1”. If the CPU 301 determines that the sheet replace flag is not set to be “1”, it stores, in the NVMEM 304, the information indicating the sheet size identified during execution of the print processing as new size information indicating the size of sheets stacked in the sheet feeding unit 735.

On the other hand, if the CPU 301 determines in step S608 that the sheet replace flag is set to be “1”, it never stores any information indicating the sheet size identified during execution of the print processing in the NVMEM 304. That is, the CPU 301 completes the print processing without storing, in the NVMEM 304, the information indicating the sheet size identified during execution of the print processing as size information indicating a size of sheets stacked in the sheet feeding unit 735. In this manner, the initialized state (that is, a state of not being set) of size information corresponding to the sheet feeding unit 735, which information is stored in the NVMEM 304, is maintained.

As described above, in a case where the printing apparatus 101 detects a possibility of replacement of sheets stacked in the sheet feeding unit to those of a different size during execution of print processing, it does not store a size of a sheet identified during conveyance as that of sheets stacked in the sheet feeding unit upon completion of the print processing. On the other hand, in a case where the printing apparatus 101 detects a possibility of replacement of sheets stacked in the sheet feeding unit to those of a different size before print processing is started, it stores the identified size of the sheet as a size of sheets stacked in the sheet feeding unit. Thus, even when sheets are replaced during execution of print processing in the printing apparatus 101, an incorrect size can be prevented from being stored as a size of sheets stacked in the sheet feeding unit.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-264743, filed Dec. 3, 2012, which is hereby incorporated by reference herein in its entirety.

What is claimed is:

1. A printing apparatus comprising:
a memory unit configured to store a size of a sheet stored in a sheet storage unit;
an identifying unit configured to identify a size of a sheet conveyed from the sheet storage unit; and
a control unit configured to control not to store the size of the sheet identified by the identifying unit as the size of the sheet stored in the sheet storage unit in a case where the sheet storage unit is opened during conveyance of the sheet, and to control to store the size of the sheet identified by the identifying unit as the size of the sheet stored in the sheet storage unit in a case where the sheet storage unit is not opened during conveyance of the sheet.

2. The apparatus according to claim 1, further comprising a determination unit configured to determine whether or not a sheet is stored in the sheet storage unit,
wherein even in the case where the sheet storage unit is not opened during conveyance of the sheet, when the determination unit determines that no sheet is stored in the sheet storage unit, the control unit controls not to store the size of the sheet identified by the identifying unit as the size of the sheet stored in the sheet storage unit.

3. The apparatus according to claim 1, wherein in a case where the control unit controls not to store the size of the sheet identified by the identifying unit, the control unit controls to store a size of a sheet identified by the identifying unit when next print processing is executed.

4. The apparatus according to claim 1, wherein the control unit controls to store the size of the sheet identified by the identifying unit as the size of the sheet stored in the sheet storage unit after completion of conveyance of the sheet.

5. The apparatus according to claim 1, wherein in a case where a plurality of sheets are conveyed from the sheet storage unit upon execution of print processing, opening and closing of the sheet storage unit is inhibited during conveyance of a sheet other than a last sheet of the plurality of sheets, and opening and closing of the sheet storage unit is permitted during conveyance of the last sheet of the plurality of sheets.

6. The apparatus according to claim 1, further comprising a sensor configured to be used to detect a size of a sheet conveyed from the sheet storage unit,
wherein the identifying unit identifies a size of a sheet conveyed from the sheet storage unit based on an output from the sensor.

7. The apparatus according to claim 1, further comprising a display control unit configured to display, on a display unit, a message which prompts a user to replace a sheet stored in the sheet storage unit before print processing is started, in a case where a size stored in the memory unit is different from a size of a sheet required for the print processing.

8. The apparatus according to claim 1, further comprising a print unit configured to print an image on the sheet based on the size stored in the memory unit.

9. A control method of a printing apparatus comprising steps of:
storing, in a memory unit, a size of a sheet stored in a sheet storage unit;
identifying a size of a sheet conveyed from the sheet storage unit; and
controlling not to store the size of the sheet identified in the identifying step as the size of the sheet stored in the sheet storage unit in a case where the sheet storage unit is opened during conveyance of the sheet, and controlling to store the size of the sheet identified in the identifying step as the size of the sheet stored in the sheet storage unit in a case where the sheet storage unit is not opened during conveyance of the sheet.

10. A computer-readable storage medium storing a computer program for causing a computer to execute steps of a control method of a printing apparatus comprising steps of:
storing, in a memory unit, a size of a sheet stored in a sheet storage unit;
identifying a size of a sheet conveyed from the sheet storage unit; and
controlling not to store the size of the sheet identified in the identifying step as the size of the sheet stored in the sheet storage unit in a case where the sheet storage unit is opened during conveyance of the sheet, and controlling to store the size of the sheet identified in the identifying step as the size of the sheet stored in the sheet storage unit in a case where the sheet storage unit is not opened during conveyance of the sheet.
